(19) United States
(12) Patent Application Publication
(10) Pub. No.: US 2026/0088199 A1
(43) Pub. Date: Mar. 26, 2026

(54) SINGLE-PART SHIELD PRODUCED BY TENSILE COMPRESSIVE FORMING

(71) Applicant: Siemens Energy Global GmbH & Co. KG, München (DE)

(72) Inventors: Alexander Hartung, Berlin (DE); Martin Koletzko, Baiersdorf OT Igelsdorf (DE); Armin Grund, Berlin (DE)

(21) Appl. No.: 19/111,414

(22) PCT Filed: Aug. 31, 2023
(86) PCT No.: PCT/EP2023/073913

§ 371 Date: Mar. 13, 2025

(30) Foreign Application Priority Data
Sep. 13, 2022 (DE) 10 2022 209 537.5

(51) Int. Cl. H01B 17/00

(52) U.S. Cl. CPC H01B 17/005

(57) ABSTRACT

A single-part shield is produced by tensile compressive forming for tubular insulators in high-voltage technology. The single-part shield does not require the production process needed to connect, by hard soldering or welding, the parts in a conventional multi-part shield. This eliminates a connection point which also eliminates the risk that the closure soldering will not succeed.

The invention relates to a shielding for an insulator in high-voltage technology.

In vacuum switching tubes, an insulation gap may consist of multiple interconnected insulators. The insulators are interconnected by means of a metal layer on the front sides. That metal layer is electrically conductive and is shielded. Moreover, an insulator may be connected to a metallic part. This contact region is also shielded.

The shieldings consist of a flat cylindrical region, with the front sides of the insulators fastened to upper and lower sides thereof. At the edge of the cylindrical region, the shielding is elongated in the axial direction. This creates a thin cylinder or cone with a torus or part of a torus located at an end thereof.

The shielding must act in both the positive and negative directions of the axis. It must therefore act both along the axis of the first insulator and along the axis of the second insulator. The shielding is usually produced by tensile compressive forming. It has previously been produced from multiple parts which have to be interconnected. This may be done by hard soldering or welding.

The invention is based on the object of providing a shielding for insulators in high-voltage technology which requires reduced effort compared with a conventional shielding.

The object is attained by a shielding with the features of claim 1.

The single-part shielding according to the invention does not require the production process needed to connect, by hard soldering or welding, the parts in a conventional multi-part shielding. Eliminating the connection point also eliminates the risk that the closure soldering will not succeed.

Preferred developments of the invention are stated in the dependent claims.

In the following, the invention will be explained in more detail as an exemplary embodiment to the extent necessary for comprehension with reference to figures. In the drawings:

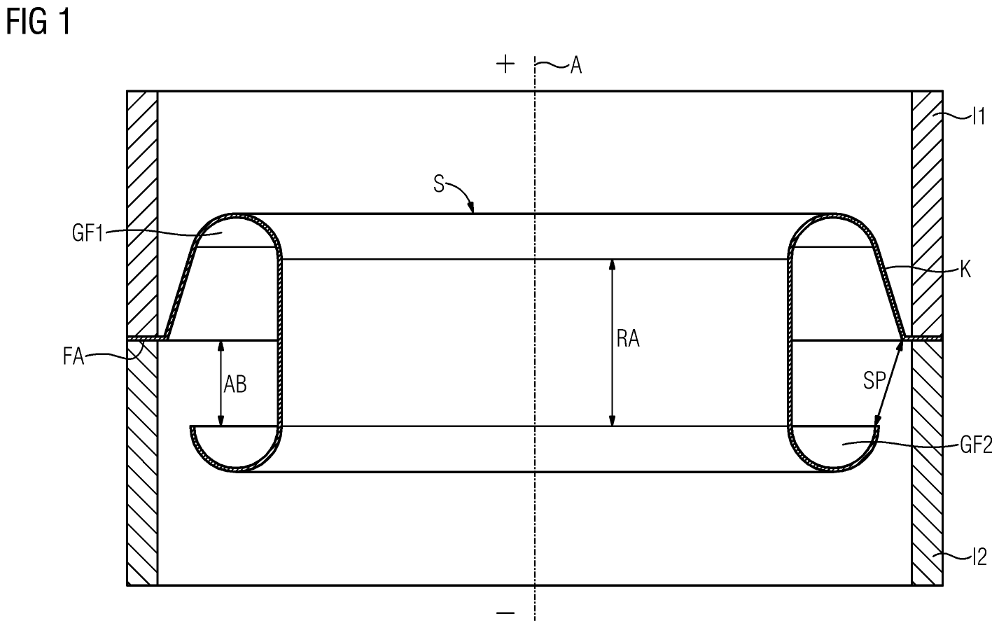

FIG. 1 shows a shielding according to the invention between two insulators,

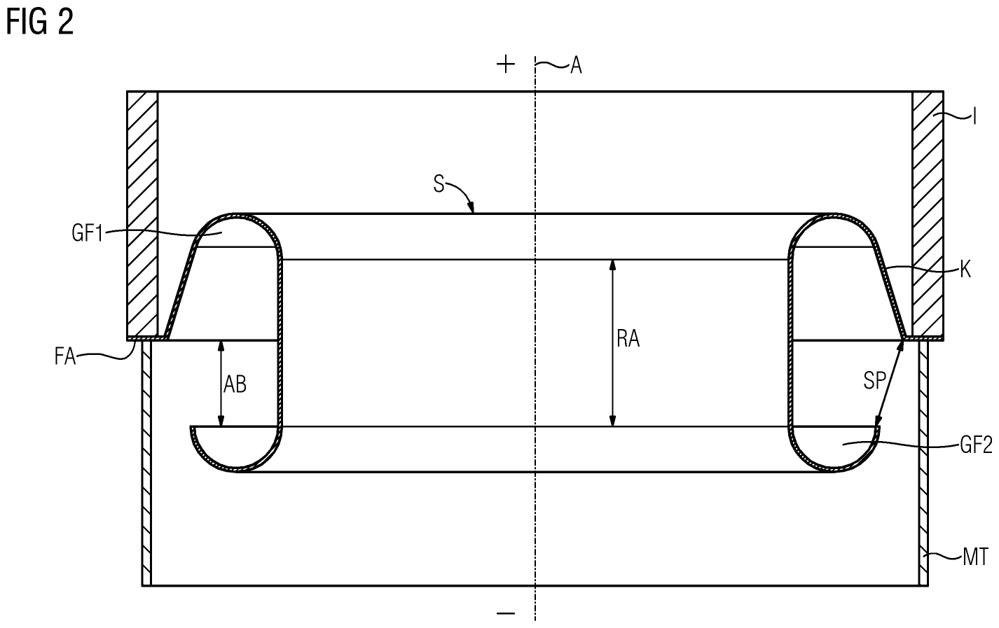

FIG. 2 shows a shielding according to the invention between an insulator and a metallic part, and

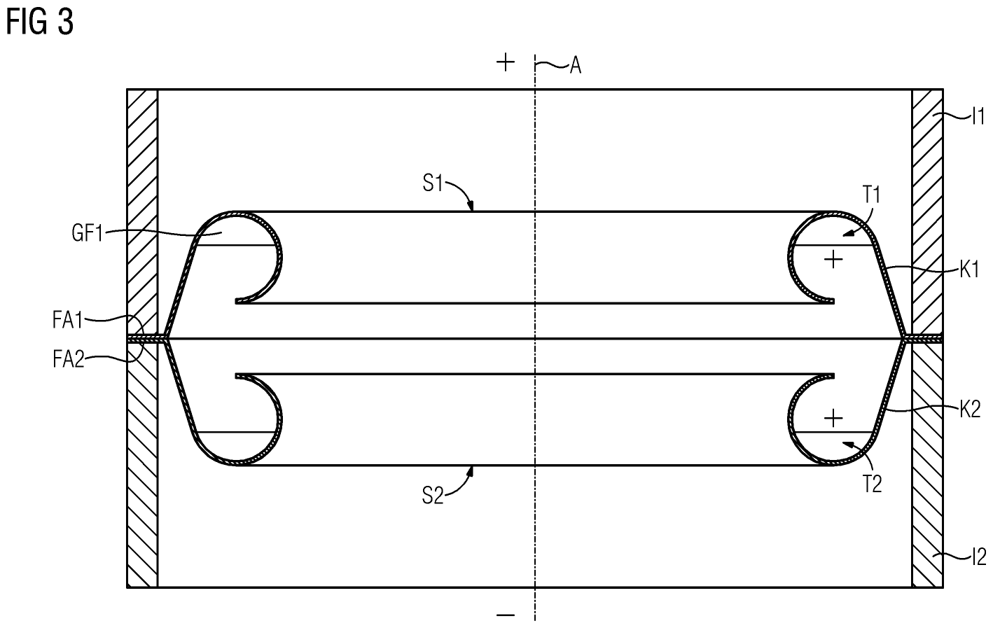

FIG. 3 shows a conventional two-part shielding.

In the figures, identical designations denote identical elements.

In the conventional shielding in a two-part design shown in FIG. 3, a first shielding S1 is given which has a flat annular portion FA1. At the inner edge of portion FA1, the shielding is elongated by a conical portion K1 in the direction of axis A. The end of the conical portion K1 facing axis A is adjoined by a torus T1, but also part of a torus T1, such that the cross-section of the shielding S1 is approximated to the shape of a question mark “?” and the torus T1 does not intersect the plane of the FA1. The first shielding S1 and a second shielding S2 identical thereto are interconnected in a mirror-inverted manner at their portions FA1 and FA2, which may be realized, for example, by hard soldering or welding. Tubular insulators I1 and I2, respectively, are connected to the surfaces of the portions FA1 and FA2 facing away from the connection.

In the shielding according to the invention in a single-part design shown in FIG. 1, a shielding S is given which has a flat annular portion FA. At the inner edge of portion FA, the shielding is elongated by a conical portion K in the direction of the axis A. The end of the conical portion K facing the axis A is adjoined by a first surface GF1 curved towards the plane of the portion FA which is bent about the axis A, has a circular segment-like shape in cross-section and has a tubular portion RA with a substantially constant diameter formed thereon. At the tubular portion RA, a second surface GF2 curved towards the plane of portion FA is formed, which is bent about the axis A and has a circular segment-like shape in cross-section. The loose end of the second curved surface GF2 faces the flat annular portion FA such that an open slot SP remains. The conical portion K, the first curved surface GF1, the tubular portion RA and the second curved surface GF2 form an incompletely closed torus with a circumferential slot SP, the torus extending above and below the plane of the portion FA. Axis A of the tubular portion RA is intersected by the plane of portion FA orthogonally. The plane of portion FA intersects the tubular portion RA perpendicularly. The front sides of the tubular insulators I1 and I2, respectively, which are arranged concentrically to the axis A, are connected to the upper side and the lower side of the portion FA.

In the shielding according to the invention shown in FIG. 2, a shielding S is given in a single-part design which is identical to the shielding S of FIG. 1. A tubular insulator I and a metallic part MT, which are arranged concentrically to the axis A, are connected to the upper side and the lower side of the portion FA. The metallic part MT has a smaller wall thickness than the insulator I.

The circumferential slot SP in the torus of the shielding S is arranged facing the metallic part MT.

The shielding S according to the invention is produced from a component, for example from thin sheet metal, by tensile compressive forming. In a first forming step, the first torus GF1, but also part of a torus, is produced. In a further forming step, the second torus GF2, but also part of a torus, is produced.

The present invention has been explained in detail for illustration purposes with reference to particular exemplary embodiments. In this regard, elements of the individual exemplary embodiments may also be combined with one another. The invention should therefore not be limited to individual exemplary embodiments but should merely be subject to limitation by the appended claims.

### LIST OF REFERENCE NUMERALS

A—Central axis
AB—Spacing
FA1—Shielding S1 flat portion
FA2—Shielding S2 flat portion
GF1—First curved surface
GF2—Second curved surface
K1—First conical portion
K2—Second conical portion
I—Insulator
I1—First insulator
I2—Second insulator
MT—Metallic part
RA—Tubular portion
S—Shielding
S1—First shielding
S2—Second shielding
SP—Slot
T1—Torus 1
T2—Torus 2
+—Positive direction of axis A
−—Negative direction of axis A

1-5. (canceled)

6. A shielding for an insulator in high-voltage technology, the shielding comprising:
a flat annular portion concentric to an axis and having an inner edge;
at said inner edge of said flat annular portion, a conical portion is formed and inclined in a positive direction of the axis and towards the axis;
at an end of said conical portion, a first curved surface curved in a negative direction of the axis and towards the axis is formed, said first curved surface being bent concentrically about the axis and having a circular segment shape in cross-section;
at an end of said first curved surface facing the axis, a tubular portion concentric to the axis and with a substantially constant radius with respect to the axis is formed;
at an end of said tubular portion oriented in the negative direction of the axis, a second curved surface curved in the positive direction of the axis and towards said inner edge of said flat annular portion is formed, which is bent concentrically about the axis and has a circular segment shape in cross-section;
from the axis, a radius of a free end of said second curved surface is smaller than a radius of said inner edge of said flat annular portion;
said free end of said second curved surface has a spacing from a plane of said flat annular portion in the negative direction of the axis; and
the plane of said flat annular portion intersects said tubular portion orthogonally.

7. The shielding according to claim 6, wherein said flat annular portion cooperates with a front face of the insulator.

8. The shielding according to claim 6, wherein said flat annular portion cooperates with a front face of a tubular metallic part.

9. The shielding according to claim 6, wherein the shielding is produced from thin sheet metal by tensile compressive forming.

10. The shielding according to claim 6, wherein said first curved surface is produced in a first forming step, and said second curved surface is produced in a second forming step.
